(19) United States
(12) Patent Application Publication
(10) Pub. No.: US 2014/0015704 A1
(43) Pub. Date: Jan. 16, 2014

(54) METHOD AND APPARATUS TO PROTECT A TARGET AGAINST A MINIMUM OF ONE ATTACKING MISSILE

(71) Applicant: Peter Huber, Bischofswiesen (DE)

(72) Inventor: Peter Huber, Bischofswiesen (DE)

(21) Appl. No.: 14/007,404

(22) PCT Filed: Mar. 28, 2012
(86) PCT No.: PCT/EP2012/055571

§ 371 Date: Sep. 25, 2013

(30) Foreign Application Priority Data
Mar. 28, 2011 (DE) 10 2011 001 608.2
Aug. 11, 2011 (DE) 10 2011 052 616.1

(51) Int. Cl. H01Q 15/16; F41H 11/02; H01Q 15/14

(52) U.S. Cl. CPC H01Q 15/16; H01Q 15/14; F41H 11/02
USPC 342/9; 342/5

(57) ABSTRACT

This invention describes an application and its methodology to protect a target against a minimum of one attacking missile through timely optimized ship maneuvers by using known RCS calculations against radar and/or infrared guided missiles. This application also provides the necessary measurement and analysis abilities of the many possible positions, or physical constraints a ship may need to be in, in order to significantly increase the effectiveness of current shipborne “state of the art” soft-kill systems against attacking unmanned missiles.

### INTRODUCTION

The present invention relates to a method and an apparatus used for the protection or defense of a target against a minimum of one attacking missile by using a ship borne control system that provides distraction against the attacking missile.

### BACKGROUND

In order to protect a ship against attacking missiles employing a homing device, the ship being attacked will deploy decoys which will present false targets or jam the electronics and/or sensors of the attacking missile. These techniques are commonly referred to as “Soft Kill”. The intention of these types of countermeasures is to lure the attacking missile off its intended flight path and away from its intended target. Such Soft-Kill systems focus on deploying pyrotechnical projectiles which contain metallic, heat and/or fog developed payloads which provide larger or hotter echoes to radar or infrared homing devices that may be housed as part of the sensor package in the nose of the attacking missile. Ideally, the best result is deceiving the missile in angle so to lessen the aspect of fly-through.

For example purposes, and for the remainder of this document, the term “ship” will be referred to as the target. Although the constraints to protect a ship command special and additional restraints, this product can also be used in protecting tanks or other moving or stationary type targets.

The object of this invention is to significantly improve the effectiveness of modern soft-kill countermeasures and defensive systems which are currently used onboard ships to protect them against attacking, unmanned missiles. From the list of available missile sensors, this device will focus against any given missile that uses Radar as their primary sensor. This object is achieved by using the features of claim 1. For a decoy to be effective, the radar cross section of the decoy must be more “attractive” to the attacking missile when the missile sensor compares it against the radar cross section of the ship. It is possible to generate a wall of radar echoes by deploying decoys to bloom at various heights with hopes of thwarting a hit by the closing missile. However, according to the present invention, it is suggested to minimize the radar cross section (RCS) of the ship as seen by a radar guided missile through the use of optimized maneuvers in conjunction with the deployment of soft-kill munitions. Thus, a method to protect a target like a ship against at least one attacking missile is characterized in that in parallel to emission of decoys, based on analysis of advantageous and disadvantageous ship's positions for individual threats and sea states, a reduction of the radar cross section RCS of a ship during a threat of a radar and/or infrared guided missile is achieved by initiating time optimized ship's maneuvers. The following RCS description referring to FIG. 2, relates to any given ship being analyzed.

Favorable improvements of this invention are subject-matter of the sub-claims. Thus, a timely synchronization of the launch of decoys is advantageously to be initiated together using suggested maneuvers of the ship causing that the method is executed in conjunction with the launch of pyrotechnical defense systems, jammers and/or corner reflectors or the like. Further, the method may be executed using the analyzed data of the ship as a target of the attack of at least one missile in order to optimize the use of decoys, where in an embodiment the method is additionally executed using the analyzed data of the target in order to optimize the time window in which the decoys or a minimum of one radar jammer are deployed with the aim of misguiding the missile. According to a further embodiment of the invention pre-calculated values for an optimized ship maneuver are retrieved from a database and they are depicted on a screen whereby real-time ship movements and related RCS values are calculated during the threat phase and recorded in order to compare with existing recommendation, particularly for training purposes. Further, for any given target and particularly onboard a ship respective situations and maneuvers are recorded and/or restored for training purposes. Additionally, in a further development on board a ship as a target, optimized maneuver data with focus on RCS of the ship are being derived in conjunction with real-time data of the threat as well as environmental data (sea state/wind) are being displayed, recorded and/or restored. Advantageously, a calculation of the direction of approach of the S-System from the direction of approach form an I-System is calculated as well as pitch and roll angles are measured. Further, a calculation of necessary types, sizes and arrangement of decoys in relation to their positioning (time behavior) and effectiveness (RCS behavior) in relation to existing decoy systems is carried out in an embodiment of the invention. Further, a calculation of the time of use and time window for use of radar jammer is performed.

The above object is further achieved by an apparatus for protecting a target against at least one attacking missile pro-viding means for the realization of a method according to any of the preceding claims, a computer with a database is used containing results of calculation of maneuverability of a ship from a current position is used with a reaction time of approximately 40 to 60 sec taking into account external environmental influences (wind drift) and data from a RCS measurement, as well as existing or estimated data of an attacking missile can be stored and retrieved any time, in order to recommend the optimum maneuver. Further, this appliance may be built for training-, evaluation- and maneuver purposes. Whereas the present invention is described here having a focus on the situation on a ship under attack by at least one missile, the method disclosed may apply to air planes or tanks and the like, too.

Subsequent exemplary embodiments of the invention, including additional features and their advantages, will be explained in more detail with reference to the drawings. In the drawings are shown:

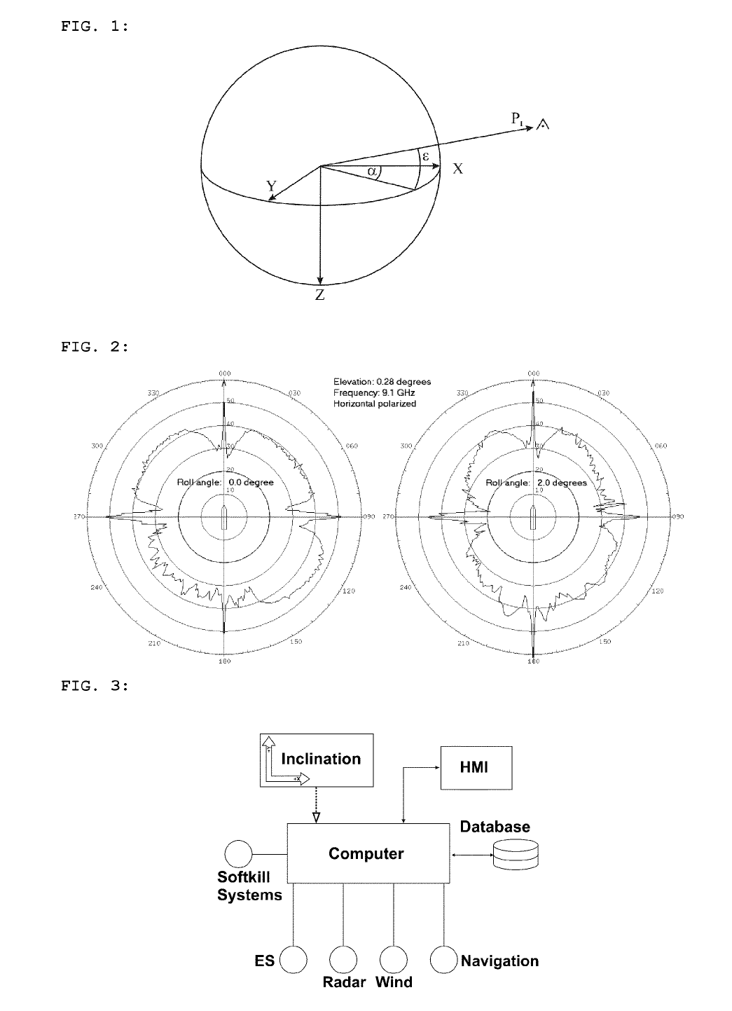

FIG. 1: an inertial system within a unit sphere used to illustrate the subsequently used coordinates;

FIGS. 2a and 2b: polar diagrams for the RCS value of a ship without pitch and roll by using a ship's roll angle of 2.0 degrees, each for an elevation ∈_{I} of the missile of 0.28 degrees;

FIG. 3: a build-up of a system for the implementation of a method according to the invention;

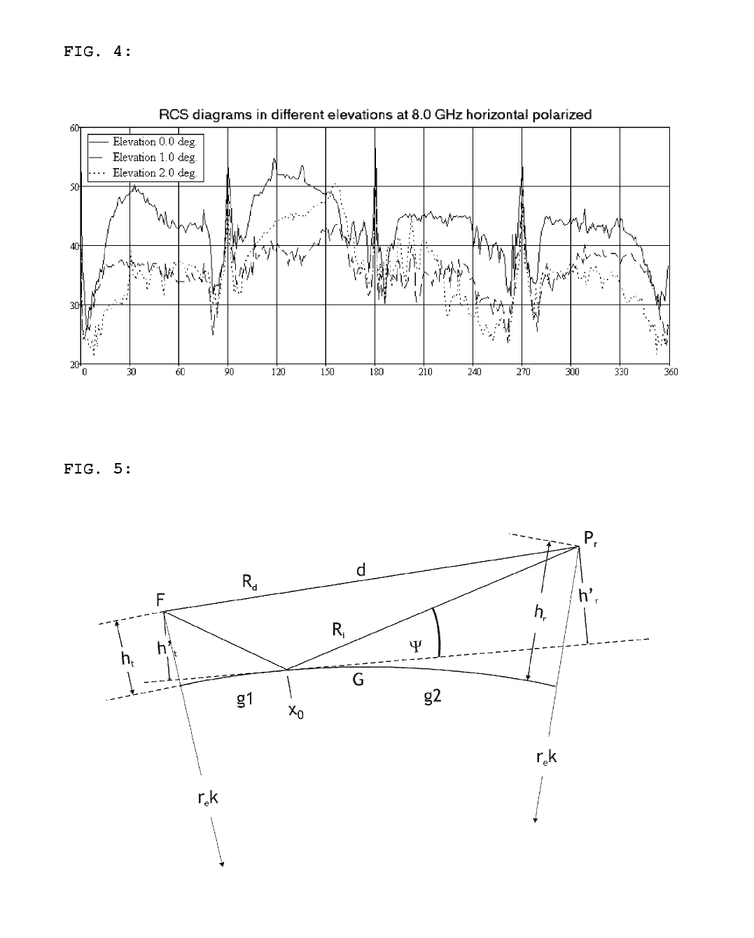

FIG. 4: a dB diagram of CAD RCS measurements result in 360 degrees azimuth and for elevations of 0.0 degrees, 1.0 degrees and 2.0 degrees;

FIG. 5: a sketch of a direct reflection R_{d} and an indirect reflection from a surface Rᵢ of an reflection point P from a target to the radio source F;

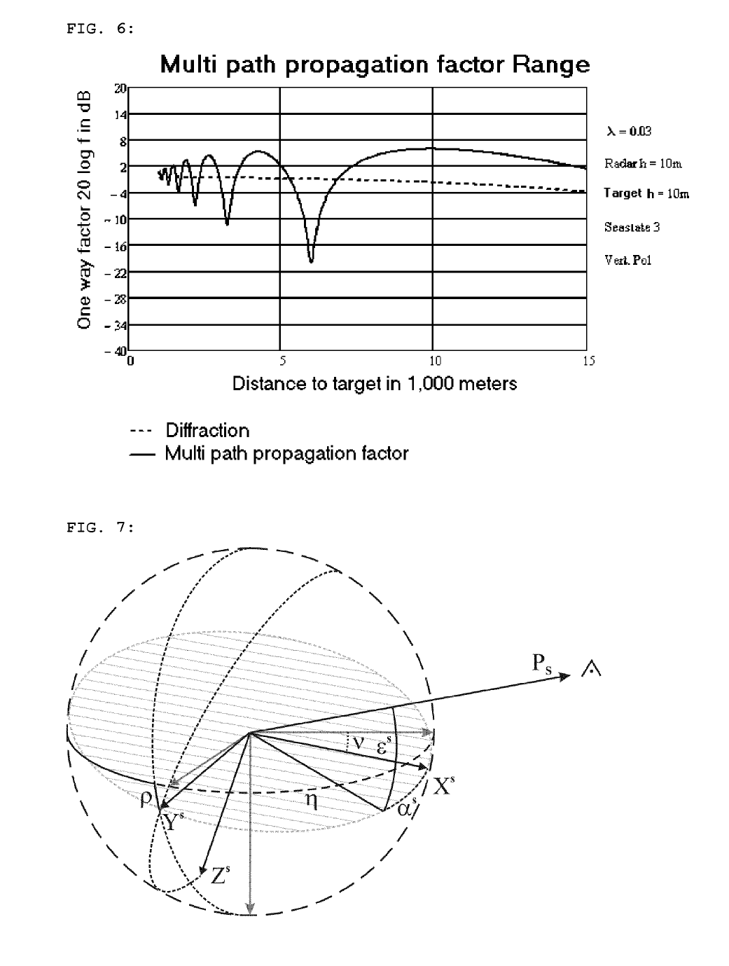

FIG. 6: multi-path propagation factor for one direction;

FIG. 7: S-system twisted in relation to an I-system and a direction of approach in the said system;

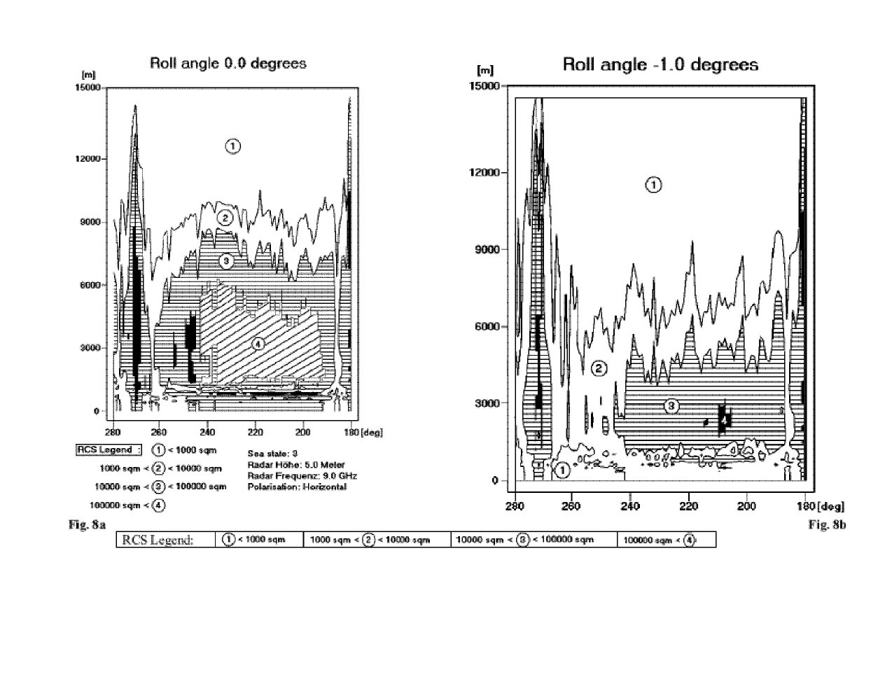

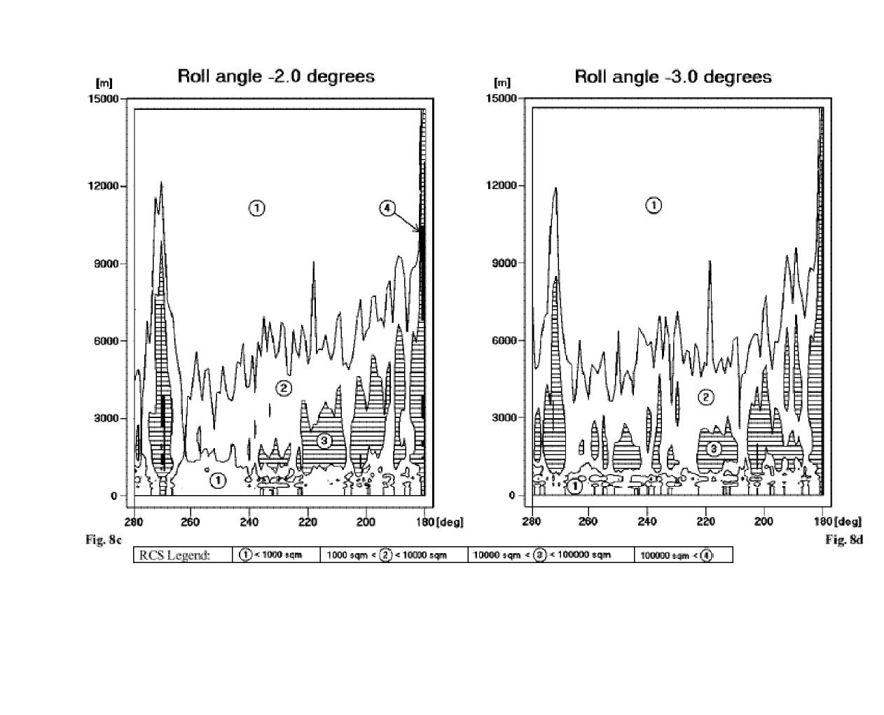

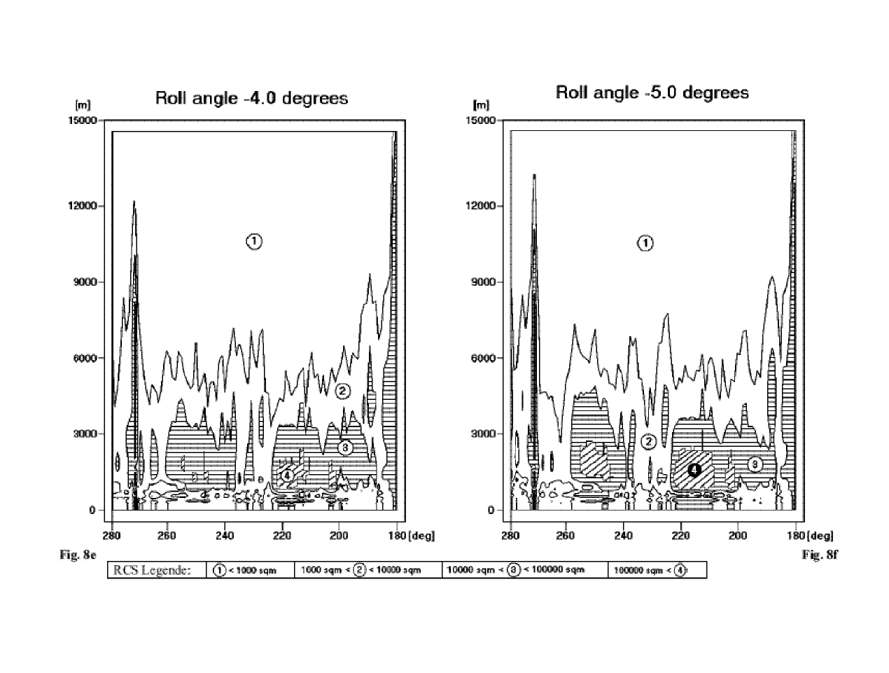

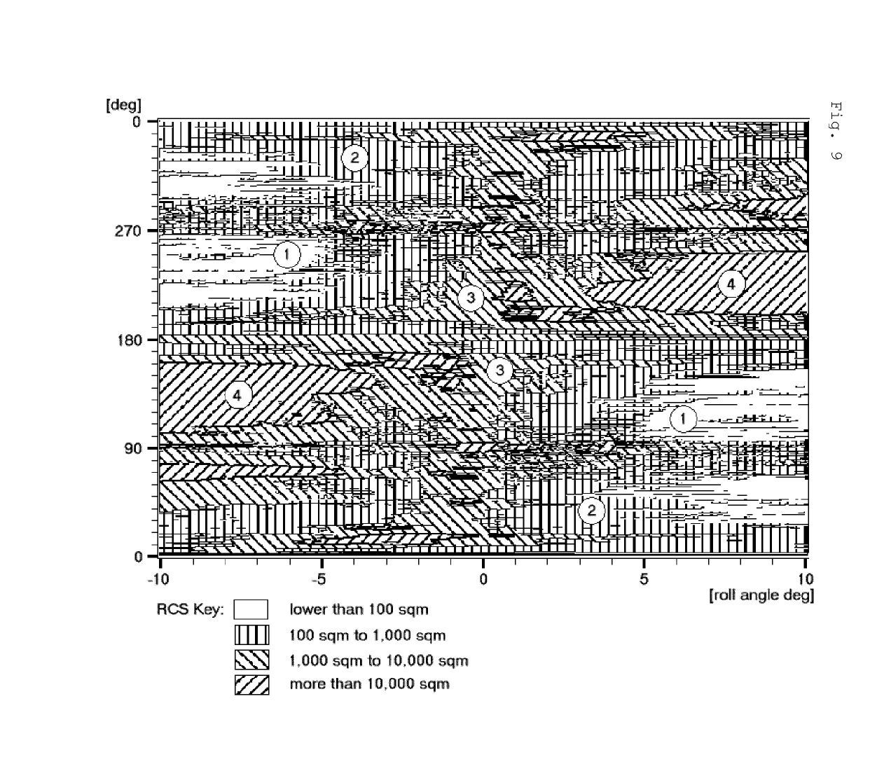

FIGS. 8a to 8f: a RCS behavior of a ship model and different distances (x-Axis) and threat directions (y-Axis) for a given missile using a defined frequency, polarization and cruise height within a defined sea state. Visualization of different roll angles along the ship's center line and

FIG. 9: a RCS model of a ship model in 360 degrees azimuth (y-Axis) for roll angle between −10.0 and 10.0 degrees (x-Axis).

Identical designations and reference numerals for assemblies, elements, coordinates, processes or assembly groups are used as standard over the various drawings and are not limited to the referenced figures.

The radar cross section RCS of a 3-dimensional target is the amount of reflection of the said target back to the source of radiation (attacking missile radar). In mathematical formulae, the radar cross section is referenced with the Greek letter σ (sigma) and has the unit “Square Meter”. The RCS depends on the design and material of the target as well as on wave length, polarization and direction of the radio wave towards the target in azimuth α and elevation ∈ in relation to an inertial system I; e.g. an earth-referenced coordinate system, with its z axis pointing in the direction of gravity and x axis pointing in north-south direction. Desired RCS calculations should be used within the same frequency range to that expected to be used by the attacking missile.

FIG. 1 illustrates a generic sketch, which shows the target direction p of an inertial system I. Also in FIG. 1, the unit sphere originates or revolves around the I-system in a way that the angle in circular measure can be illustrated as a segment of a circle. For the size of the reflection generated or for the RCS of a non-uniform object the directional bias of the reflective surfaces towards the source of radiation that provides the reflective RCS or measurement. It is known that the size of the RCS of a ship varies in relation to the direction of the radiation source in elevation and azimuth.

For an approaching missile, the direction between its intended target, here in particular and without limitation a ship, and the source of radiation, e.g. radar of the missile, is not constant. The elevation of the direction of approach in relation to the ship's position in the I-system depends on the distance of the missile to the ship as well as on the cruise height of the missile above the ship's position. The azimuth in the I-system is variable due to any maneuvers the missile may do. The clear position of the ship as reference point is clearly defined in half length, half width and half height above water in the ship's center.

In addition to changes in elevation and azimuth angles within the I-System, the actual reflection angles ∈_{S} and α_{S} of the ship's own coordinate system, the so called S-System, change due to ship's own movement. The ship's own movement is characterized by:
(a) Rolling around the ship's center line in bow direction of the ship;
(b) Pitching around the ship's lateral axis;
(c) Change of course in relation to ship's bow direction; and
(d) Change of speed.

Pitching and rolling is caused by sea state and the resulting waves. Additionally, rolling can be influenced by heeling which is the inclined position of the ship due to centrifugal forces and loading. For the present invention, in particular, the heeling caused by centrifugal forces due to change of course and respective angle, is of paramount interest. For a short period of time of about 5-15 sec the RCS of the ship can be altered intentionally.

FIG. 2 illustrates the polar diagram of the RCS of any given ship without pitching and rolling being introduced, as well as a polar diagram with a ship's roll angle of 2.0 degrees and for an elevation ∈_{I} of the missile of 0.28 degrees. The values in the polar diagram are dB, whereas the following relations apply: 10 dB=10 sqm, 20 dB=100 sqm, 30 dB=1,000 sqm, 40 dB=10,000 sqm and 50 dB=100,000 sqm. FIG. 2 clearly illustrates that the RCS' influence of rolling is significant. In conjunction with the ship's course changes, in relation to the threat direction, and depending on the ships geometrical structure, significant changes of the RCS, within a limited timeframe, are achievable.

A method according to the invention allows calculation of both desirable and undesirable ship locations which can be used for individual threats well in advance. This can greatly improve the protecting ships response time or readiness in order to optimize the effective deployment of decoys or soft-kill techniques.

The calculated areas depend strongly on the distance of the missile due to multi-path propagation of the radar beams. This situational awareness additionally gives guidance for the timeframe, when a decoy or radar jammer(s) are used in defense against an attacking missile. Furthermore, this invention also includes an apparatus which facilitates the recording of respective missions, including any maneuvers in order to conduct last-minute instructions, onboard training or educational feedback to ships command teams or users. FIG. 3 shows a block diagram of a computer showing how pre-prepared data can be fed from claims 1 and 2 via a database. The roll and pitch of the ship is also being measured via an interfaced inclination sensor. The navigational data of the ship can also be provided via an interface to the appropriate ship's sensor. By using a Man-Machine-Interface (MMI) respectively, Human-Machine-Interface HMI threats can be inserted manually.

The computer system is calculating continually suggestions for ship maneuvers by a fuzzy controller, driven through a neural network, using the pre-calculated RCS values from the database and situational data from the sensors and shows them on a display. The intention of the calculation is the minimization of the ship's RCS and the optimization of a false targets drift through the radars track gates. The resulting values can be preferred heeling angles as well as preferred ruder angles with the ability to illustrate them on a screen. The real time ship movements and the related RCS values that are being calculated during the threat situation may be recorded and compared with given recommendations. The use of this application stand alone, or in combination with a softkill system, either onboard ship, or at a training establishment ashore, can be exercised, evaluated and optimized.

Additional sensors can be interfaced to such training equipment. This enables increased precision and efficiency of any recommendation due to automated data feeding.

The following methods for calculation of relationship between missile and ship's RCS in various radiation directions, cruise heights and distances of the missile are described. These are:
Calculation of RCS values and maneuverability of the ship;
Calculation of the influence of the multi-path propagation; and
Method for calculation of the direction of approach of the S-System derived from the direction of approach of the I-System as well as the measured pitch and roll data ν and ρ according to claim 6.

### Ship's Data Calculation

In order to minimize the radar cross section of a ship during a threat situation caused by a radar guided missile, detailed knowledge of the ship (amongst other things RCS, maneuverability and maneuver behavior) and the missile (amongst other things frequency, distance, speed, cruise height and polarization) are of paramount importance. The data for any given ship is gathered prior to any potential threat situation and stored inside a database on the ship. Missile data can be stored inside a database as well. Due to the fact that a missile's characteristic and electronic emission information is typically classified data, the emission intercept data can also be derived from a ship's own Electronic Support ES (passive radar detection equipment) during a threat situation. These systems are routinely fitted to monitor the radio frequency spectrum onboard naval warships. Dynamic missile parametrics, e.g. distance, can be derived from the timely behavior of the missile as detected via the ship's own radar systems. Dynamic ship data, e.g. pitch and roll of the ship, are derived from an inclination sensor and be provided on a real-time basis. The methods for determination of the needed data necessary for calculations are described below.

### Ship's RCS:

In order to derive a precise RCS model it is necessary to chart the object. The RCS measurement of a ship at sea with a high resolution in azimuth and elevation is a difficult task. Additionally there will be external failure sources e.g. reflection, deflection and also instability of the ship due to pitch and roll which are almost impossible to be extracted from measurement results. Hence the software CAD RCS is being used for the RCS measurements of the ship which will derive the RCS model for various frequencies via a CAD model of the ship. The credibility of the results delivered by this software has already been verified experimentally.

FIG. 4 illustrates the result of a RCS measurement with CAD RCS for 360 degrees azimuth with an underlying resolution of 1 degree and elevations of 0.0 degree, 1.0 degree and 2.0 degree in dB units. The resolution of the RCS model should be a least 0.1 degrees in azimuth and elevation. Additionally, the software measures the height of relevant reflection points over sea level from the RCS model. The results of the RCS model are stored inside a database. The entries inside the database can be retrieved for any given elevation and azimuth angles. The input values for any given entry are elevation, azimuth, frequency and polarization of the threat. The resulting output then contains the RCS value as well as the positions xᵢ, yᵢ and zᵢ of all reflection points/surfaces i with a RCS greater than a predefined minimum value.

### Maneuverability/Maneuver Behaviors:

Maneuverability is characterized by the acceleration behavior, as well as, its turn rates and heeling behavior in various rudders angles and speeds. This kind of data can be gathered amongst others by the measurement of cruise dynamic parameters with aid from inertial platforms. This data are stored inside a ship's own database. If measurements from hydrodynamic tests are available, these could be used as well.

### Missile Data:

Missile data can also be derived from Electronic Support intercepts or measures and ship's own radar intelligence measures if not available via classified databases.

### Calculation of the Influence of Multi-Path Propagation:

Additionally, the direct reflection of the radio waves from the object the multi-path propagation of radar beams caused by reflection and deflection on the water surface needs to be considered. The influence of multi-path propagation depends on the wavelength and polarization of the emitting source, the distance d between emitting source and point of reflection at the target, the heights h′ₜ between emitting source (transmitter) and h′ᵣ of the reflection point at the target over the tangent of the reflection point on the surface of the water at the spherical earth surface as well as the properties of the reflecting surface, e.g. sea water.

FIG. 5 illustrates a generic sketch of direct reflection R_{d} and indirect reflection at the surface Rᵢ of a reflection point P at the target to the emitting source F. Due to the fact that radio waves can range beyond the visual horizon this additional quasi-visual range must be considered. By default, an earth radius magnification factor of k=4/3is assumed for the radius rₑ.

The following derivations are known from Ref. 1 and derived from there:

For any given reflection point height hᵣ, a transmitter height hₜ (emitting source and antenna height) and a target distance d the surface distance G results as

$$G = {r}_{e} \cdot k \cdot {cos}^{- 1} [ \frac{{( {r}_{e} k + {h}_{t} )}^{2} + {( {r}_{e} k + {h}_{r} )}^{2} - {d}^{2}}{2 ( {r}_{e} k + {h}_{t} ) ( {r}_{e} k + {h}_{r} )} ] \qquad ( 1 )$$

Assuming a smaller target height the following simplification applies:

$$G = {r}_{e} k \cdot {sin}^{- 1} [ \frac{d}{{r}_{e} k} ] \qquad ( 2 )$$

The position of the reflection point X₀ is being derived from the solution of the cubic equations with supporting parameters p and φ

$$p = \sqrt{\frac{4 {r}_{e} k ( {h}_{t} + {h}_{r} ) + {G}^{2}}{3}} \\ and \\ φ = {cos}^{- 1} [ \frac{2 {r}_{e} k ( {h}_{r} - {h}_{t} ) \cdot G}{{p}^{3}} ] \qquad ( 3 )$$

Consequentially, the surface distance between radar and reflection point calculates as follows:

$${g}_{1} = \frac{G}{2} - p cos [ \frac{φ + π}{3} ] \qquad ( 4 )$$

Constructing a tangent at the reflection point of the surface calculates the transmitter and target height as follows:

$${h}_{t}^{′} = {h}_{t} - \frac{{g}_{1}^{2}}{2 {r}_{e} k} \\ {h}_{r}^{′} = {h}_{t}^{′} ( \frac{G}{{g}_{1}} - 1 ) \qquad ( 5 )$$

The angle of incidence ψ calculates as follows:

$$ψ = {tan}^{- 1} ( \frac{{h}_{t}^{′}}{{g}_{1}} ) \qquad ( 6 )$$

The elevation angle from the radar to the target is defined as:

$$θ = {sin}^{- 1} [ \frac{{h}_{r} - {h}_{t}}{d} - \frac{d}{2 {r}_{e} k} ] \qquad ( 7 )$$

The difference of the distance of the reflected beam is defined as:

$${δ}_{0} = \frac{2 {h}_{r}^{′} {h}_{t}^{′}}{G} \qquad ( 8 )$$

The influence of the multi-path propagation also depends on the properties of the reflecting surface. Therefore the reflective coefficient ρ calculates as the product of the “Fresnel Reflection”ρ_{f}, the dispersion caused by mirroring on the surface (Dispersion Coefficient) ρₛ and the Vegetation factor ρᵥ. As the vegetation factor will have no influence above water it is assumed as 1.0 in this case. The Fresnel Reflection Coefficient describes the relation between the reflecting, respectively the transmitted amplitude, of the incoming electro-magnetic wave at a dielectric boundary layer.

For a horizontal polarization the complex reflection coefficient calculates as:

$${ρ}_{hor} = \frac{sin ψ - \sqrt{{ɛ}_{c} - {cos}^{2} ψ}}{sin ψ + \sqrt{{ɛ}_{c} - {cos}^{2} ψ}} with \\ {ɛ}_{c} = {ɛ}_{r} - i \cdot 60 λ {σ}_{e} \qquad ( 9 )$$

∈ᵣ=Dielectric constant of the surface

σₑ=Conductivity of the surface

For vertical polarization the following holds:

$${ρ}_{ver} = \frac{{ɛ}_{c} \cdot sin ψ - \sqrt{{ɛ}_{c} - {cos}^{2} ψ}}{{ɛ}_{c} \cdot sin ψ + \sqrt{{ɛ}_{c} - {cos}^{2} ψ}} \qquad ( 10 )$$

The magnitude of the Fresnel Reflection Coefficient ρ_{f} is being calculated from the absolute value of the complex number

ρ_{f}|ρ_{hor,ver}| (11)

The angle of the Fresnel Reflection Coefficient β calculates from the argument of the complex number

β=arg(ρ_{h,v}) (12)

For the phase angle of the reflected beam the following holds:

$$α = \frac{2 π }{λ} \cdot {δ}_{0} + β \qquad ( 13 )$$

For a rough surface with an average square deviation σₕ from a flat surface the dispersion coefficient calculates as follows:

$${ρ}_{s} = exp [ - \frac{1}{2} {( \frac{4 π {σ}_{h}}{λ} sin ψ )}^{2} ] \qquad ( 14 )$$

The value of σₕ depends on the height of the waves of the water surface (sea state). Based on the formula of Moskowitz the following values for σₕ are being used for the respective wave bights:

| Sea state | description | σₕ in m |
|---|---|---|
| 0 | calm (glassy) | 0.00 |
| 1 | calm (rippled) | 0.05 |
| 2 | smooth (wavelets) | 0.11 |
| 3 | slight | 0.25 |
| 4 | moderate | 0.46 |
| 5 | rough | 0.76 |
| 6 | very rough | 1.2 |
| 7 | high | 2.0 |
| 8 | very high | 3.0 |
| 9 | phenomenal | >3.5 |

Neglecting the divergence angle for small incoming angles ψ, the multi-path propagation factor calculates from the absolute value of the complex number:

fₚ=|1.0+ρₕ·ρₛ·exp(α·i)| and in dB: Fₚ=20·log(fₚ) (15)

FIG. 6 shows the multi-path propagation factor for one direction (with transmitter pointed towards the target) with a wavelength of λ=0.03 meter, a transmitter height of 10 meter, and a reflection point height of 10 meter at sea state 3 in vertical polarization. For calculating the way to the target and back this factor must be multiplied by 2.

### Transformation of the Angle of Approach/Threat Direction From the I-System to the S-System:

The threat direction in the inertial system I and the ship's own coordinate system S, as described in DE 103 08 308 A1, has a different use and aim: the threat direction TI within the inertial system I is defined by the azimuth α_{I} based on axis X_{I} and elevation ∈_{I} towards the horizontal pane E_{I} defined by X_{I} and Y₁. The elevation ∈_{I} is derived from the cruise height and distance of the missile in relation to the ship. The elevation and azimuth angles in which the ship is tracked by the missile's radar are derived by means of azimuth α_{S} and elevation ∈_{S} in relation to a ship's originated coordinate system; the x axis X_{S} aiming in bow's direction of the ship.

The X_{S}-Y_{S} pane is not co-planar to the X_{I}-Y_{I} pane, through the influence of the sea state or ships heeling when rudder angles are changed in course alterations. The ship is more or less rolling constantly along its center line X_{S} and pitches along its lateral axis Y_{S}. The yaw effect can be neglected since the I-system analyses the threat direction T_{I} via ship's own sensors and subsequently transforms it north-oriented. For simplicity purposes, the x axis of the inertial system can be considered abrading to the x axis of the ship's own system. Through this, the azimuth must not be transformed to north and back again.

The ship's own system and the inertial system are also not identical; hence an approaching missile does not see the ship in elevation ∈_{I} and Azimuth α_{I} but in elevation ∈_{S} and azimuth α_{S} of the ship's own system.

FIG. 7 illustrates a transformed S-system in relation to the I-System as well as the direction of approach in the indicated system. The hashed area indicates the ship's system (S-System).

Another object of the invention is to provide an apparatus and a method that calculate elevation ∈_{S} and azimuth α_{S} from pitch and roll data of a platform in motion in relation to the inertial system I.

This object is achieved as follows:

The method for calculating the threat angle ∈_{S} and α_{S} in order to derive the respective RCS data, includes the following steps:
a. Determination of the azimuth angle α_{I} of the threat axis in relation to the bow direction of the ship (X_{S}). As described above, a double transformation back and forth in north-orientation is neglected;
b. Determination of the elevation angle ∈_{I} from the cruise height and the distance of the missile to the ship's centre point within the abadant inertial system I;
c. Determination of the pitch angle ν between the x axis of the ship's own system in bow direction and the x axis of the abadant inertial system via a first measurement device; and
d. Determination of the roll angle ρ between the y axis of the ship's own system and the perpendicular pane of the abadant inertial system in relation to the z axis via a second measurement device.

As measurement device for the pitch and roll measurements an inclination sensor or any other similar device can be used. Each has to be calibrated in x axis of the ship's own system.

The X_{S} axis within the inertial system calculates as

$${X}_{S}^{I} = ( \begin{matrix}cos ( v ) \\ 0 \\ sin ( v )\end{matrix} ) \qquad ( 16 )$$

with the elevated index being the illustration of the inertial system I.

The Y_{S} axis within the inertial system calculates as

$${Y}_{S}^{I} = ( \begin{matrix}cos ( ρ ) \cdot cos ( η ) \\ cos ( ρ ) \cdot sin ( η ) \\ sin ( ρ )\end{matrix} ) \qquad ( 17 )$$

Whereas the angle η is derived from the perpendicularity of the x axis and the y axis.

cos(η)=−tan(ρ)tan(ν) (18)

The Z_{S} axis calculates from the inertial system as cross product of the x axis and y axis as

$${Z}_{S}^{I} = ( \begin{matrix}- sin ( v ) cos ( ρ ) \cdot sin ( η ) \\ sin ( ρ ) cos ( v ) - sin ( v ) cos ( ρ ) \cdot cos ( η ) \\ cos ( v ) cos ( ρ ) sin ( η )\end{matrix} ) \qquad ( 19 )$$

The target direction within the ship's own system S calculates as

P_{S}=A_{IS}^{T}·P_{I} (20)

with the direction of approach within the inertial system

$${P}_{I} = ( \begin{matrix}cos ( {ɛ}_{I} ) \cdot cos ( {α}_{I} ) \\ cos ( {ɛ}_{I} ) \cdot sin ( {α}_{I} ) \\ - sin ( {ɛ}_{I} )\end{matrix} ) \qquad ( 21 )$$

respectively within the ship's own system as

$${P}_{S} = ( \begin{matrix}cos ( {ɛ}_{S} ) \cdot cos ( {α}_{S} ) \\ cos ( {ɛ}_{S} ) \cdot sin ( {α}_{S} ) \\ - sin ( {ɛ}_{S} )\end{matrix} ) \qquad ( 22 )$$

and the transformation matrix from the S system into the I system who's column build up the x, y and z axes of the S system.

$${A}^{T} = ( \begin{matrix}cos ( v ) & cos ( ρ ) \cdot cos ( η ) & - sin ( v ) cos ( ρ ) \cdot sin ( η ) \\ 0 & cos ( ρ ) \cdot sin ( η ) & sin ( ρ ) cos ( v ) - sin ( v ) cos ( ρ ) \cdot cos ( η ) \\ sin ( v ) & sin ( ρ ) & cos ( v ) cos ( ρ ) sin ( η )\end{matrix} ) \qquad ( 23 )$$

By careful attention to the sign of the main values of arcsine and arccosine, azimuth α_{S} and elevation ∈_{S} within the ship's own system can directly be derived from the inertial system α_{I}, ∈_{I} and the simultaneously measured pitch and roll angles ν and ρ using formula (20) and solving for α_{S} respectively ∈_{S}:

$$sin ( {ɛ}_{S} ) = cos ( {ɛ}_{I} ) \cdot cos ( {α}_{I} ) \cdot sin ( v ) \cdot cos ( ρ ) \cdot sin ( η ) ++ [ sin ( v ) \cdot cos ( ρ ) \cdot cos ( η ) - sin ( ρ ) \cdot cos ( v ) ] \cdot cos ( {ɛ}_{I} ) \cdot sin ( {α}_{I} ) ++ sin ( {ɛ}_{I} ) \cdot cos ( v ) \cdot cos ( ρ ) \cdot sin ( η ) \\ cos ( {ɛ}_{S} ) \cdot cos ( {α}_{S} ) = cos ( {ɛ}_{I} ) \cdot cos ( {α}_{I} ) \cdot cos ( v ) -- sin ( {ɛ}_{I} ) \cdot sin ( v ) \qquad ( 24 )$$

A dedicated script or routine in a personal computer (PC) can quickly do this calculation.

A model can be calculated, based on the availability of data, for potentially any given missile or expected threat, to understand the trend of the RCS behavior in various maneuvers from the information above. The depicted differences in RCS values from FIG. 2, based on the position of the missile, can now be calculated for any given direction or distance from any given ship's position, along with the consideration of the multi-path propagation and the respective sea state.

The calculation of this model is described as following:

Contrary to the calculation of the ship's RCS values via the CAD RCS software the model is calculated with a resolution of 1 degree in azimuth and 10 meters distance of the missile. This is more than sufficient for any analysis of the RCS behavior in different pitch and roll angles. However, the high resolution of the ship's RCS is necessary in order to avoid rounding errors when transforming the direction of approach. The calculation of this model is executed iterative for azimuth angles α_{I} ranging from 0-359 degrees and for distances off the radar source from 15,000 m to 100 m. The cruise height, frequency and polarization are defined by the missile to be analyzed. Models can be calculated to various roll angles and sea states.
a) Calculation of the elevation ∈_{I} derived from the distance and height differential to the ship's reference point

$${ɛ}_{I} = atan ( \frac{Δ h}{d} ) \qquad ( 25 )$$

b) Calculation of α_{S} and elevation ∈_{S} within the S-system for any roll angle ρ and pitch angle ν to be analyzed, whereas the pitch angle will be set to 0 regularly during the model calculation; it will only be taken into account during a real time calculation of the training system on board. Calculation is done via formula (24). Alternatively, by using the onboard training system, the minimum and maximum values of the pitch movement can be recorded and their influence to the roll angles can be derived.
c) Extraction of the coordinates and RCS values from all reflection points/areas from the RCS database with the input parameters α_{S}, ∈_{S}, frequency and polarization.
d) Calculation of the RCS values of the ship from the sum of RCS values from the RCS values of individual reflection points/areas multiplied with the factor of the multi-path propagation on the way back and forth of the radar beams in relation of their height and distance, see formulae 1-15.

An appropriate computer needs less than 1 second for the above described iterative calculation.

FIGS. 8a to 8f, illustrates an example for a RCS behavior of the ship in aspect angles ranging from 180 degrees to 270 degrees, with different distances (x axis) and threat directions (y axis) for a missile with a defined frequency at 9.0 GHz, horizontal polarized, and a missile attack height of 5 meters above sea level at sea state 3. The scale of the RCS will be depicted in color in practical use. For the FIGS. 8a to 8f a simple classification into 4 categories is used. The RCS for areas marked with ‘1’ is below 1,000 sqm. Areas marked by ‘2’ have RCS values between 1,000 and 10,000 sqm. An area marked by ‘3’ indicates RCS values from 10,000 to 100,000 sqm. Areas marked by 4 have RCS values higher than 100,000 sqm.

The RCS behavior in FIGS. 8a to 8f is depicted for roll angles ranging from 0.0 degrees to −5.0 degrees in 1 degree resolution. The illustration shows how huge the influence of the roll movement to the reflection in dependence to the ship's geometry can be. Particularly for roll angles between −1.0 degrees and 4.0 degrees, the RCS value can significantly be reduced for the given ship's model and the used missile parameters. These results can be stored in a database and be used for maneuver recommendations.

FIGS. 8a to 8f further illustrates, that a decoy used in conjunction with a recommended maneuver, will have an optimum decoying effect for the missile, at distances between 9,000 and 3,500 meters. The launch time should be chosen in a way that the decoy is available within this time frame and the separation between ship and decoy is realized prior the distance of 3,500 meters is reached.

FIG. 9 illustrates an example for the RCS behavior in different roll angles. Using this knowledge, an unfavorable balance of RCS can be avoided, while favorable can be established by the heeling effect during a ship's maneuver.

Preceding used references: Ref. 1:

[David K. Barton 2005]

Radar System Analysis and Modeling

Artech House Boston, London, ISBN 1-58053-681-6

1. A method to protect a ship as a target against at least one attacking missile, wherein on the basis of simultaneously to deploying decoys timely optimized maneuvers and acting forces are being measured calculated, recommended and executed in order to achieve advantageous positions with minimal radar cross section (RCS) in direction of the at least one attacking missile as well as avoiding disadvantageous positions with high radar cross section (RCS) in direction of the at least one attacking missile by achieving a certain heeling effect of the target, where rolling is influenced by heeling caused by centrifugal forces due to change of course and respective angle for a short period of time of about 5-15 sec for intentionally altering the radar cross section (RCS) of the ship.

2. A method according to claim 1, wherein the method is executed in conjunction with the launch of pyrotechnical defense systems, jammers and/or corner reflectors or the like.

3. A method according to claim 1, wherein the method is executed using the analyzed data of the ship as a target of the attack of at least one missile in order to optimize the use of decoys.

4. A method according to claim 1, wherein the method is executed using the analyzed data of the target in order to optimize the time window in which the decoys or a minimum of one radar jammer are deployed with the aim of misguiding the missile.

5. A method according to claim 1, wherein pre-calculated values for an optimized ship maneuver are retrieved from a database and being depicted on a screen whereby real-time ship movements and related RCS values are calculated during the threat phase and recorded in order to compare with existing recommendation, particularly for training purposes.

6. A method according to claim 1, wherein for any given target and particularly onboard a ship respective situations and maneuvers are being recorded and/or restored for training purposes.

7. A method according to claim 1, wherein on board a ship as a target, optimized maneuver data with focus on RCS of the ship are being derived in conjunction with real-time data of the threat as well as environmental data (sea state/wind) are being displayed, recorded and/or restored.

8. A method according to claim 1, wherein a calculation of the direction of approach of the S-System from the direction of approach form an I-System is calculated as well as pitch and roll angles (ν, p) are measured.

9. A method according to claim 1, wherein a calculation of necessary types, sizes and arrangement of decoys in relation to their positioning (time behavior) and effectiveness (RCS behavior) in relation to decoy systems available at the target is carried out.

10. A method according to claim 1, wherein a calculation of the time of use and time window for use of radar jammer is performed.

11. An apparatus for protecting a target against at least one attacking missile characterized in, that means for the realization of a method to protect a ship as a target against at least one attacking missile, wherein on the basis of simultaneously to deploying decoys timely optimized maneuvers and acting forces are being measured calculated, recommended and executed in order to achieve advantageous positions with minimal radar cross section (RCS) in direction of the at least one attacking missile as well as avoiding disadvantageous positions with high radar cross section (RCS) in direction of the at least one attacking missile by achieving a certain heeling effect of the target, where rolling is influenced by heeling caused by centrifugal forces due to change of course and respective angle for a short period of time of about 5-15 sec for intentionally altering the radar cross section (RCS) of the ship the apparatus comprising a computer linked to a database containing results of calculation of maneuverability of a target from a current position with a reaction time of approximately 40 to 60 sec taking into account external environmental influences (wind drift) and data from a RCS measurement, as well as measured or estimated data of an attacking missile stored and retrieved, where the apparatus further creates an output of resulting values containing to a recommended optimum maneuver by means of preferred heeling angles as well as preferred ruder angels for intentionally altering the RCS of the ship for a short period of time of about 5-15 sec.

12. An apparatus according to, wherein apparatus further comprises means to illustrate preferred heeling angles as well as preferred ruder angles on a screen.

13. An apparatus according to claim 11, wherein the appliance is built for training(-), evaluation(-) and maneuver purposes.
